(19) United States
(12) Patent Application Publication
(10) Pub. No.: US 2022/0412743 A1
(43) Pub. Date: Dec. 29, 2022

(54) METHOD AND DEVICE FOR CALCULATING ANCHORING AREA OF SHIP

(71) Applicant: WUHAN UNIVERSITY OF TECHNOLOGY, Wuhan (CN)

(72) Inventors: FAN ZHANG, Wuhan (CN); Chunhui Zhou, Wuhan (CN); Junnan Zhao, Wuhan (CN); Zongyang Liu, Wuhan (CN); Langxiong Gan, Wuhan (CN); Yanmin Xu, Wuhan (CN)

(21) Appl. No.: 17/901,868

(22) Filed: Sep. 2, 2022

Related U.S. Application Data
(63) Continuation of application No. PCT/CN2021/113468, filed on Aug. 19, 2021.

(30) Foreign Application Priority Data
Dec. 29, 2020 (CN) 2020115958610

(51) Int. Cl. G01C 21/20; G01C 21/10; B63B 79/40

(52) U.S. Cl. CPC G01C 21/203; G01C 21/10; B63B 79/40; G06F 16/29

(57) ABSTRACT

A method for calculating an anchoring area of a ship includes steps of obtaining ship trajectories of ships within a certain time period in an anchorage; screening out ship trajectories including an anchoring process and eliminating trajectory points in a non-anchored state in the ship trajectories to obtain anchoring trajectories of anchored ships; clustering anchoring points in each of the anchoring trajectories, using a cluster center as an anchoring position point of each of the anchored ships; establishing an anchoring data set according to the anchoring position points; selecting anchoring data records in a predetermined time period in the anchoring data set; establishing an anchored ship position point set corresponding to the predetermined time period; and establishing Thiessen polygons corresponding to the anchoring position points; calculating an area of each of the Thiessen polygons to obtain an anchoring area of a corresponding anchored ship.

### TECHNICAL FIELD

The present disclosure relates to a technical field of anchoring area calculation, and in particular to a method for calculating anchoring area of ship, a device, and a computer storage medium thereof.

### BACKGROUND

During operation of the inland port anchorage, there are many anchored ships, and the anchorage is extremely crowded. An anchoring area actually occupied by each of the anchored ships reflects a safety degree of the anchorage of the anchored ships. At present, there is still no effective measurement method for the anchoring area of each of the anchored ships.

Although the “General Design Specification for River Ports” gives calculation formulas of the anchoring area of an anchored ship under conditions of different anchoring methods in inland waters. However, there are few studies on ship anchoring area in inland waters. Calculation of the anchoring area of the anchored ships in the “General Design Specification for River Ports” is only to give certain value parameters and corresponding empirical formulas in a general manner, which lacks a clear theoretical basis and cannot adapt to demands of a development trend of inland waterway shipping.

### SUMMARY

In view of this, it is necessary to provide a method and device for calculating an anchoring area of a ship, so as to solve a problem that the anchoring area of the ship cannot be effectively measured.

The present disclosure provides a method for calculating an anchoring area of a ship. The method comprises following steps:

obtaining ship trajectories of ships within a certain time period in an anchorage;

screening out ship trajectories including an anchoring process and eliminating trajectory points in a non-anchored state in the ship trajectories including the anchoring process to obtain anchoring trajectories of anchored ships;

clustering anchoring points in each of the anchoring trajectories, and using a cluster center of the anchoring points of each of the anchoring trajectories as an anchoring position point of each of the anchored ships;

establishing an anchoring data set according to the anchoring position point of each of the anchored ships; selecting anchoring data records in a predetermined time period in the anchoring data set; and establishing an anchored ship position point set corresponding to the predetermined time period; and establishing Thiessen polygons one-to-one corresponding to the anchoring position points in the anchored ship position point set; calculating an area of each of the Thiessen polygons to obtain an anchoring area of a corresponding anchored ship.

Furthermore, the step of obtaining the ship trajectories of the ships within the certain time period in the anchorage comprises:

obtaining automatic identification system (AIS) data of each of the ships within the certain time period in the anchorage; wherein the AIS data of each of the ships comprises static information and dynamic information; the dynamic information of each of the ships comprises ship position information, ship speed information, and heading information; and

generating the ship trajectories according to the ship position information, the ship speed information, and the heading information of each of the ships; and marking each of the ship trajectories of each of the ships based on the static information of each of the ships.

Furthermore, the step of obtaining the ship trajectories of the ships within the certain time period in the anchorage further comprises:

screening out and eliminating the trajectory points in the ship trajectories where ship positions are not within a predetermined anchorage range or ship speeds are greater than a predetermined speed;

grouping the ship trajectories according to the maritime mobile service identify (MMSI) identification code to obtain the ship trajectory of each of the ships; and

storing the trajectory points of each of the ship trajectories of each of the ships in time sequence.

Furthermore, the step of screening out the ship trajectories including the anchoring process and eliminating the trajectory points in the non-anchored state in the ship trajectories including the anchoring process to obtain the anchoring trajectories of the anchored ships comprises:

traversing each of the ship trajectories through a sliding window of a predetermined size; calculating an average ship speed of trajectory points in any one of trajectory intervals of each of the ship trajectories of each of the ships during a sliding process of the sliding window; determining whether the trajectory intervals of each of the ship trajectories comprise a trajectory interval where an average ship speed of the trajectory interval is less than a speed threshold value; if yes, determining that a corresponding ship comprises an anchoring process and removing other trajectory intervals in a corresponding ship trajectory where the average ship speed is less than the speed threshold value; and obtaining the anchoring trajectory of the corresponding ship, if not, determining that the corresponding ship does not comprise the anchoring process.

Furthermore, the step of clustering the anchoring points in each of the anchoring trajectories, and using the cluster center of the anchoring points of each of the anchoring trajectories as the anchoring position point of each of the anchored ships comprises;

obtaining the cluster center of the anchoring points of each of the anchoring trajectories based on a K-means clustering algorithm to obtain the anchoring point of each of the anchored ships

Furthermore, the step of establishing the anchoring data set according to the anchoring position point of each of the anchored ships comprises:

recording an anchoring position, a length of the anchored ship, a ship type, an anchor drop time, and an anchor lift time of each of the anchored ships to obtain the anchoring data record of each of the anchored ships; and

establishing the anchoring data set according to the anchoring data record of each of the anchored ships.

The present disclosure further provides a device for calculating the anchoring area of the ship. The device comprises a processor and a memory. A computer program is stored on the memory. When the computer program is executed by the processor, the computer program calculates the anchoring area of the ship by the method for calculating the anchoring area of the ship.

The present disclosure further provides a computer storage medium. The computer storage medium comprises a computer program stored in the computer storage medium. When the computer program is executed by a processor, the computer program calculates the anchoring area of the ship by the method for calculating the anchoring area of the ship.

In the present disclosure, the ship trajectories that do not comprise the anchored state are firstly screened out. Further, the trajectory points in the non-anchored state in the ship trajectories that comprise the anchored state are screened out to obtain the anchoring trajectories of the anchored ships in the anchored state, so as to select the anchored ships in the anchored state, which is convenient for subsequent calculation of the anchoring area of each of the anchored ships. Then, the anchoring process of each of the anchored ships are clustered and each cluster center is used as the anchoring position of each of the anchored ships, which realizes extraction of the anchoring positions. Finally, the anchored ship position point set in the predetermined time period is established and Thiessen polygons one-to-one corresponding to the anchoring points in the anchored ship position point set is described as the anchoring areas of the corresponding anchored ships, By calculating an area of each of the Thiessen polygons, the anchoring area of each of the anchored ships is obtained. The method for calculating the anchoring area of the ship proposed by the present disclosure effectively measures a size of the anchoring area, and thereby evaluating utilization of the anchorage and the safety of the ship at the anchorage. Compared with the prior art, the method for calculating the anchoring area of the ship proposed by the present disclosure has advantages of dynamic, fast and accurate.

### BRIEF DESCRIPTION OF DRAWINGS

FIG. 1 is a flow chart of a method for calculating an anchoring area of a ship according to a first embodiment of the present disclosure.

FIG. 2 is a schematic diagram of anchoring trajectories obtained by the method for calculating the anchoring area of the ship according to the first embodiment of the present disclosure.

FIG. 3 is a schematic diagram of a clustering result obtained by the method for calculating the anchoring area of the ship according to the first embodiment of the present disclosure.

FIG. 4 is a schematic diagram of an anchored ship position point set obtained by the method for calculating the anchoring area of the ship according to the first embodiment of the present disclosure.

FIG. 5 is a schematic diagram of Thiessen polygons obtained by the method for calculating the anchoring area of the ship according to the first embodiment of the present disclosure.

### DETAILED DESCRIPTION

The optional embodiments of the present disclosure are specifically described below with reference to the accompanying drawings. The accompanying drawings form a part of the present disclosure, and together with the embodiments of the present disclosure, are used to explain the principles of the present disclosure, instead of limiting the scope of the present disclosure.

### Embodiment 1

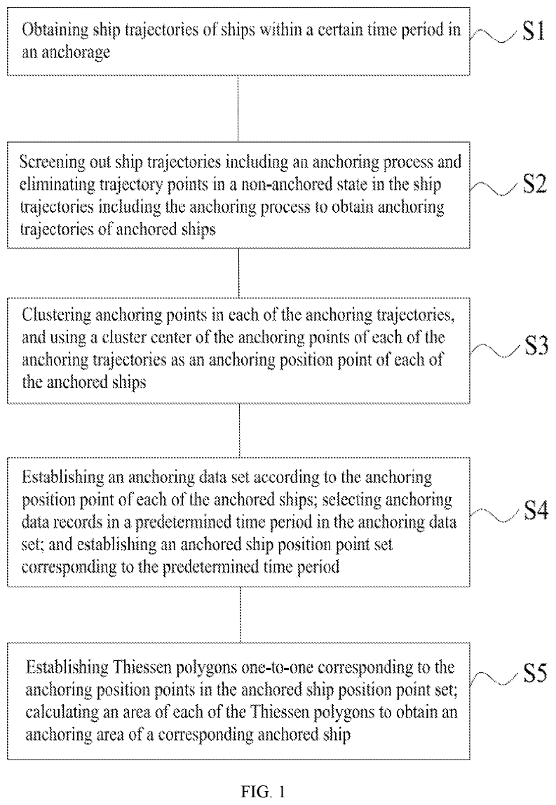

As shown in FIG. 1, the present disclosure provides a method for calculating an anchoring area of a ship. The method comprises following steps:

S1: obtaining ship trajectories of ships within a certain time period in an anchorage;

S2: screening out ship trajectories including an anchoring process and eliminating trajectory points in a non-anchored state in the ship trajectories including the anchoring process to obtain anchoring trajectories of anchored ships;

S3: clustering anchoring points in each of the anchoring trajectories, and using a cluster center of the anchoring points of each of the anchoring trajectories as an anchoring position point of each of the anchored ships;

S4: establishing an anchoring data set according to the anchoring position point of each of the anchored ships; selecting anchoring data records in a predetermined time period in the anchoring data set; and establishing an anchored ship position point set corresponding to the predetermined time period; and

S5: establishing Thiessen polygons one-to-one corresponding to the anchoring position points in the anchored ship position point set; calculating an area of each of the Thiessen polygons to obtain an anchoring area of a corresponding anchored ship.

The embodiment of the present invention starts with the ship trajectory data and the spatial analysis method, and proposes a calculation method for constructing the anchoring areas of the anchored ships based on the Voronoi diagram (i.e., the Thiessen polygons). In the present disclosure, the ship trajectories that do not comprise the anchored state are firstly screened out. Further, the trajectory points in the non-anchored state in the ship trajectories that comprise the anchored state are screened out to obtain the anchoring trajectories of the anchored ships in the anchored state, so as to select the anchored ships in the anchored state, which is convenient for subsequent calculation of the anchoring area of each of the anchored ships. Then, the anchoring process of each of the anchored ships are clustered and each cluster center is used as the anchoring position of each of the anchored ships, which realizes extraction of the anchoring positions. Finally, the anchored ship position point set in the predetermined time period is established and Thiessen polygons one-to-one corresponding to the anchoring points in the anchored ship position point set is described as the anchoring areas of the corresponding anchored ships, By calculating an area of each of the Thiessen polygons, the anchoring area of each of the anchored ships is obtained.

The method for calculating the anchoring area of the ship proposed by the present disclosure effectively measure a size of the anchoring area, and thereby evaluating utilization of the anchorage and the safety of the ship at the anchorage. Compared with the prior art, the method for calculating the anchoring area of the ship proposed by the present disclosure has advantages of dynamic, fast and accurate.

Optionally, the step of obtaining the ship trajectories of the ships within the certain time period in the anchorage comprises:

obtaining automatic identification system (AIS) data of each of the ships within the certain time period in the anchorage; wherein the AIS data of each of the ships comprises static information and dynamic information; the dynamic information of each of the ships comprises ship position information, ship speed information, and heading information; and

generating the ship trajectories according to the ship position information, the ship speed information, and the heading information of each of the ships; and marking each of the ship trajectories of each of the ships based on the static information of each of the ships.

Ship AIS system refers to a type of navigation aid system applied to maritime safety and communication between ship and shore, ship and ship. The AIS system generally comprises a Very High Frequency (VHF) communication machine, a GPS locator, and a communication controller communicated with onboard display and sensors. The AIS system is configured to automatically exchange important information such as ship position information, ship speed information, heading information, ship name information, and call sign information with an external device. The AIS system installed on the ship also receives information of other ships within coverage of the VHF communication machine while sending the information to the outside, thus realizing the automatic response.

In the embodiment, the AIS data is collected and provided by the AIS system on each of the ships. The AIS system provides static information and dynamic information of a corresponding ship. The static information comprises the name of the corresponding ship, the maritime mobile service identify (MMSI) number, the ship type, and the size of the corresponding ship. The dynamic information comprises ship position information (longitude and latitude coordinates of the corresponding ship), ship speed information, heading information, timestamp information, etc. In the embodiment, the obtained AIS data of the corresponding ship is configured to generate a corresponding ship trajectory of the ship trajectories, which is configured for subsequent acquisition of ship trajectory data of the anchored ships. When one ship is anchored, one piece of AIS data is obtained in about 3 minutes. With popularization and application of the AIS systems, a large amount of the ship trajectory data of the anchored ships are accumulated.

Optionally, the step of obtaining the ship trajectories of the ships within the certain time period in the anchorage further comprises:

screening out and eliminating the trajectory points in the ship trajectories where ship positions are not within a predetermined anchorage range or ship speeds are greater than a predetermined speed;

grouping the ship trajectories according to the maritime mobile service identify (MMSI) identification code to obtain the ship trajectory of each of the ships; and

storing the trajectory points of each of the ship trajectories of each of the ships in time sequence.

Specifically, the obtained ship trajectory data is preprocessed. After removing obvious abnormal data in the ship position and ship speed, the ships are grouped according to the MMSI identification code of the ships to obtain the ship trajectory data of each of the ships, and then the ship trajectory data is stored according to the time sequence.

Optionally, the step of screening out the ship trajectories including the anchoring process and eliminating the trajectory points in the non-anchored state in the ship trajectories including the anchoring process to obtain the anchoring trajectories of the anchored ships comprises:

traversing each of the ship trajectories through a sliding window of a predetermined size; calculating an average ship speed of trajectory points in any one of trajectory intervals of each of the ship trajectories of each of the ships during a sliding process of the sliding window; determining whether the trajectory intervals of each of the ship trajectories comprise a trajectory interval where an average ship speed of the trajectory interval is less than a speed threshold value; if yes, determining that a corresponding ship comprises an anchoring process and removing other trajectory intervals in a corresponding ship trajectory where the average ship speed is less than the speed threshold value; and obtaining the anchoring trajectory of the corresponding ship, if not, determining that the corresponding ship does not comprise the anchoring process.

In the embodiment, the preprocessed ship trajectory data is configured for anchoring identification through a sliding window algorithm. The sliding window of the predetermined size is selected to traverse each of the ship trajectories. The average ship speed v of trajectory points in each of the trajectory intervals during the sliding process of the sliding window is calculated. The speed threshold value vₜₕ is given and is configured to be compared with the average ship speed v of each of the trajectory intervals. If the trajectory intervals of each of the ship trajectories comprise the trajectory interval where the average ship speed of the trajectory interval is less than the speed threshold value; it is determined that the corresponding ship comprises the anchoring process and then the trajectory intervals of the ship trajectories of the ships where the average ship speed is less than the speed threshold value are extracted to obtain the anchoring trajectories of the anchored ships. If the ship trajectory of the corresponding ship does not comprise the period where the average ship speed of the period is less than the speed threshold value, it is determined that the corresponding ship does not comprise the anchoring process and the ship trajectory of the corresponding ship is removed.

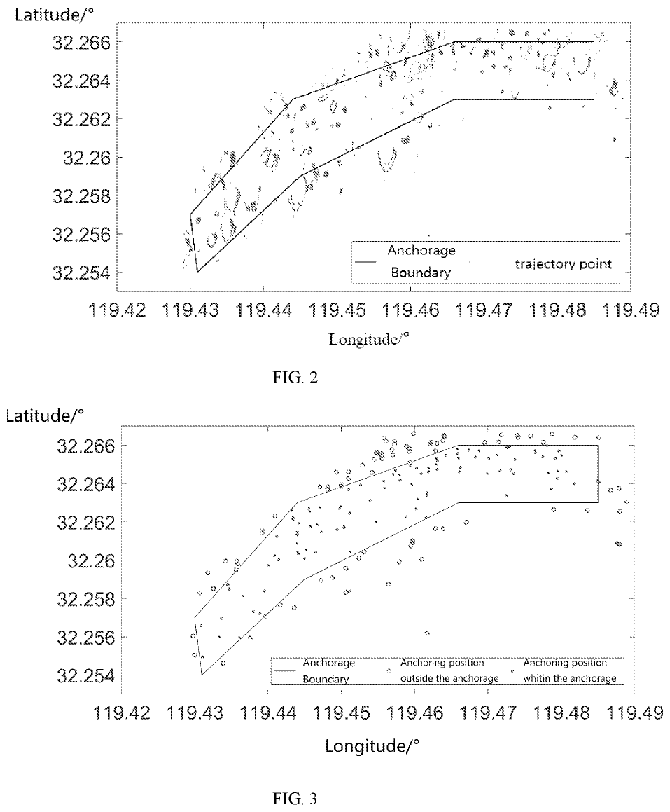

After the state of each of the ships is iteratively obtained, the trajectory points in the non-anchored state are eliminated to form the anchoring trajectory data of all anchored ships, as shown in FIG. 2.

Optionally, the step of clustering the anchoring points in each of the anchoring trajectories, and using the cluster center of the anchoring points of each of the anchoring trajectories as the anchoring position point of each of the anchored ships comprises;

obtaining the cluster center of the anchoring points of each of the anchoring trajectories based on a K-means clustering algorithm to obtain the anchoring point of each of the anchored ships

It should be understood that different clustering algorithms can be used to cluster the anchoring points in each of the anchoring trajectories. In the embodiment, as shown in FIG. 3, the K-means clustering algorithm is configured to perform density clustering on the trajectory points to obtain the cluster centers configured as the anchoring position points of the anchored ships.

Optionally, the step of establishing the anchoring data set according to the anchoring position point of each of the anchored ships comprises:

recording an anchoring position, a length of the anchored ship, a ship type, an anchor drop time, and an anchor lift time of each of the anchored ships to obtain the anchoring data record of each of the anchored ships; and establishing the anchoring data set according to the anchoring data record of each of the anchored ships.

Specifically, the anchoring position, the length of the anchored ship, the ship type, the anchor drop time, and the anchor lift time of each of the anchored ships are recorded to obtain the anchoring data set of the anchored ships

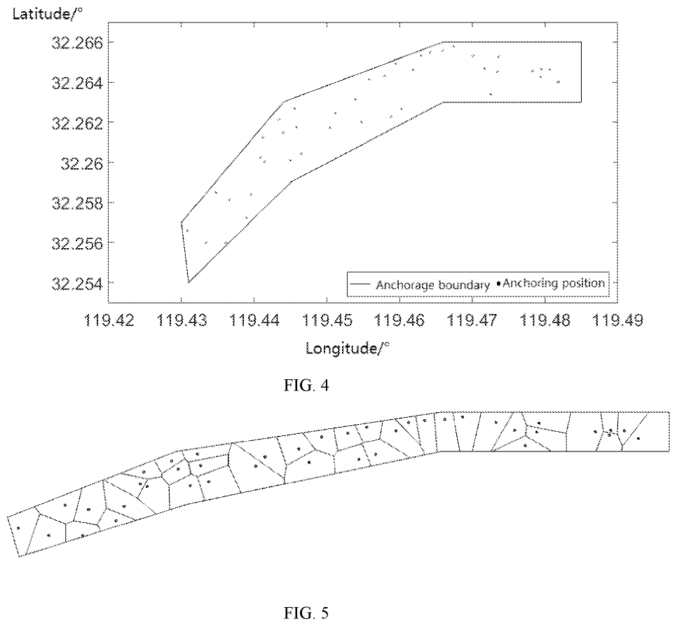

According to the anchoring data set, with a predetermined time period (e.g., in a unit of hour), the anchoring ship data in each hour of the anchoring data set is selected to construct a corresponding anchored ship position point set. As shown in FIG. 4, it shows the anchored ship position point set in one hour.

A Voronoi area in a shape of a convex polygon is assigned to each of the anchoring position points in FIG. 4, and the Thiessen polygons of some anchoring position points are shown in FIG. 5.

The anchoring area of each of the anchored ships is calculated according to each Voronoi area.

In the embodiment of the present disclosure, identification and screening process of the anchored states of the ships is firstly performed based on the sliding window. Then the anchoring positions of the anchored ships are obtained based on the clustering algorithm. Finally, the anchoring area of a single ship is constructed based on the Voronoi diagram to realize the calculation of the anchoring area of each of the anchored ships. The method for calculating the anchoring area of the ship proposed by the present disclosure effectively measure a size of the anchoring area, and thereby evaluating utilization of the anchorage and the safety of the ship at the anchorage. Compared with the prior art, the method for calculating the anchoring area of the ship proposed by the present disclosure has advantages of dynamic, fast and accurate.

### Embodiment 2

Embodiment 2 of the present disclosure provides a device for calculating the anchoring area of the ship. The device comprises a processor and a memory. A computer program is stored on the memory. When the computer program is executed by the processor, the computer program calculates the anchoring area of the ship by the method for calculating the anchoring area of the ship mentioned in Embodiment 1.

The device for calculating the anchoring area of the ship of the embodiment of the present disclosure is configured to carry out the method for calculating the anchoring area of the ship. Therefore, technical effects possessed by the method for calculating the anchoring area of the ship is also possessed by the device for calculating the anchoring area of the ship, which are not repeated herein.

### Embodiment 3

Embodiment 3 of the present disclosure provides a computer storage medium. The computer storage medium comprises a computer program stored in the computer storage medium. When the computer program is executed by a processor, the computer program calculates the anchoring area of the ship by the method for calculating the anchoring area of the ship.

The computer storage medium of the embodiment of the present disclosure is configured to carry out the method for calculating the anchoring area of the ship. Therefore, technical effects possessed by the method for calculating the anchoring area of the ship is also possessed by the computer storage medium, which are not repeated herein.

Foregoing descriptions are only optional embodiments of the present disclosure and are not intended to limit the present disclosure. Any modification, equivalent replacement, or improvement within the technical scope of the present disclosure made by those skilled in the art should be included in the protection scope of the present disclosure.

What is claimed is:

1. A method for calculating an anchoring area of a ship, comprising following steps:
obtaining ship trajectories of ships within a certain time period in an anchorage;
screening out ship trajectories including an anchoring process and eliminating trajectory points in a non-anchored state in the ship trajectories including the anchoring process to obtain anchoring trajectories of anchored ships;
clustering anchoring points in each of the anchoring trajectories, and using a cluster center of the anchoring points of each of the anchoring trajectories as an anchoring position point of each of the anchored ships;
establishing an anchoring data set according to the anchoring position point of each of the anchored ships; selecting anchoring data records in a predetermined time period in the anchoring data set; and establishing an anchored ship position point set corresponding to the predetermined time period; and
establishing Thiessen polygons one-to-one corresponding to the anchoring position points in the anchored ship position point set; calculating an area of each of the Thiessen polygons to obtain an anchoring area of a corresponding anchored ship.

2. The method for calculating the anchoring area of the ship according to claim 1, wherein the step of obtaining the ship trajectories of the ships within the certain time period in the anchorage comprises:
obtaining automatic identification system (AIS) data of each of the ships within the certain time period in the anchorage; wherein the AIS data of each of the ships comprises static information and dynamic information; the dynamic information of each of the ships comprises ship position information, ship speed information, and heading information; and
generating the ship trajectories according to the ship position information, the ship speed information, and the heading information of each of the ships; and marking each of the ship trajectories of each of the ships based on the static information of each of the ships.

3. The method for calculating the anchoring area of the ship according to claim 2, wherein the step of obtaining the ship trajectories of the ships within the certain time period in the anchorage further comprises:
screening out and eliminating the trajectory points in the ship trajectories where ship positions are not within a predetermined anchorage range or ship speeds are greater than a predetermined speed;
grouping the ship trajectories according to the maritime mobile service identify (MMSI) identification code to obtain the ship trajectory of each of the ships; and
storing the trajectory points of each of the ship trajectories of each of the ships in time sequence.

4. The method for calculating the anchoring area of the ship according to claim 1, wherein the step of screening out the ship trajectories including the anchoring process and eliminating the trajectory points in the non-anchored state in the ship trajectories including the anchoring process to obtain the anchoring trajectories of the anchored ships comprises:
traversing each of the ship trajectories through a sliding window of a predetermined size; calculating an average ship speed of trajectory points in any one of trajectory intervals of each of the ship trajectories of each of the ships during a sliding process of the sliding window; determining whether the trajectory intervals of each of the ship trajectories comprise a trajectory interval where an average ship speed of the trajectory interval is less than a speed threshold value; if yes, determining that a corresponding ship comprises an anchoring process and removing other trajectory intervals in a corresponding ship trajectory where the average ship speed is less than the speed threshold value; and obtaining the anchoring trajectory of the corresponding ship, if not, determining that the corresponding ship does not comprise the anchoring process.

5. The method for calculating the anchoring area of the ship according to claim 1, wherein the step of clustering the anchoring points in each of the anchoring trajectories, and using the cluster center of the anchoring points of each of the anchoring trajectories as the anchoring position point of each of the anchored ships comprises;
obtaining the cluster center of the anchoring points of each of the anchoring trajectories based on a K-means clustering algorithm to obtain the anchoring point of each of the anchored ships

6. The method for calculating the anchoring area of the ship according to claim 1, wherein the step of establishing the anchoring data set according to the anchoring position point of each of the anchored ships comprises:
recording an anchoring position, a length of the anchored ship, a ship type, an anchor drop time, and an anchor lift time of each of the anchored ships to obtain the anchoring data record of each of the anchored ships; and
establishing the anchoring data set according to the anchoring data record of each of the anchored ships.

7. A device for calculating an anchoring area of a ship, comprising: a processor and a memory, wherein a computer program is stored on the memory; when the computer program is executed by the processor, the computer program calculates the anchoring area of the ship by the method for calculating the anchoring area of the ship according to claim 1.

8. A computer storage medium, comprising: a computer program stored in the computer storage medium; wherein when the computer program is executed by a processor, the computer program calculates the anchoring area of the ship by the method for calculating the anchoring area of the ship according to claim 1.
